(19) United States
(12) Patent Application Publication
(10) Pub. No.: US 2021/0168690 A1
(43) Pub. Date: Jun. 3, 2021

(54) INFORMATION PROCESSING METHOD FOR A RADIO LINK FAILURE, TERMINAL, AND NETWORK DEVICE

(71) Applicant: VIVO MOBILE COMMUNICATION CO.,LTD., Chang'an Dongguan (CN)

(72) Inventors: Qian ZHENG, Chang'an Dongguan (CN); Xiaodong YANG, Chang'an Dongguan (CN); Wei BAO, Chang'an Dongguan (CN)

(73) Assignee: VIVO MOBILE COMMUNICATION CO.,LTD., Chang'an Dongguan (CN)

(21) Appl. No.: 17/175,409

(22) Filed: Feb. 12, 2021

Related U.S. Application Data
(63) Continuation of application No. PCT/CN2019/098556, filed on Jul. 31, 2019.

(30) Foreign Application Priority Data
Aug. 16, 2018 (CN) 201810935951.6

(51) Int. Cl. H04W 36/30; H04W 76/15; H04W 76/19

(52) U.S. Cl. CPC H04W 36/305; H04W 76/19; H04W 76/15

(57) ABSTRACT

The present invention provides an information processing method for wireless link failure, a terminal, and a network device. The information processing method for wireless link failure is applied to the terminal, and comprises: determining whether a first condition is satisfied; if the first condition is satisfied, sending the information of the wireless link failure of a master cell group (MCG) to a secondary cell group (SCO); and receiving MCG reconfiguration information sent by the SCG; wherein the first condition at least comprises that a failure occurs to the wireless link between the terminal and the MCG.

### CROSS REFERENCE TO RELATED APPLICATIONS

This application is a continuation application of International Application No. PCT/CN2019/098556 filed on Jul. 31, 2019, which claims priority to Chinese Patent Application No. 201810935951.6, filed on Aug. 16, 2018 in china, which is incorporated herein by reference in its entirety.

### TECHNICAL FIELD

The present disclosure relates to the field of communications technologies, and in particular, to an information processing method for a radio link failure, a terminal, and a network device.

### BACKGROUND

Dual connection is a technology introduced in long term evolution (Long Term Evolution, LTE) and will also be used in new radio (New Radio, NR). Dual connection means that user equipment (User Equipment, UE, also referred to as a terminal) may be connected to two base stations at the same time, and the two base stations provide data receiving and sending services for the UE at the same time. Because radio resources of the two base stations may be used at the same time, the service data transmission rate of the UE can be doubled.

There is a signaling interface between the two base stations serving the same UE, and the interface can exchange configuration information related to the UE.

The serving base stations of the dual-connection UE may belong to a same RAT (RAT), for example, are two LTE eNBs, or may belong to different RATs, for example, are one LTE eNB and one NR gNB.

One of the serving base stations of the dual-connection UE is a master base station (Master Node, MN) and the other is a secondary base station (Secondary Node, SN). Each base station can support the carrier aggregation (Carrier Aggregation, CA) technology. The network configures two special cells (special cell) for the dual-connection UE, that is, a serving cell of the MN is configured as a primary serving cell (Primary Cell, PCell) of the UE, and a serving cell of the SN is configured as a primary secondary serving cell (Primary Secondary Cell, PSCell) of the UE. Other cells of the MN and the SN that serve the UE are secondary serving cells (Secondary Cell, SCell) of the UE. All serving cells of the MN are collectively referred to as a master serving cell group MCG (Master cell group), and all serving cells of the SN are collectively referred to as a secondary serving cell group SCG (Secondary cell group).

In the related art, a radio link failure (Radio Link Failure, RLF) between the UE and the MCG triggers a radio resource control (Radio Resource Control, RRC) re-establishment process, and transmission that is being performed by the UE needs to be suspended and user experience is affected.

### SUMMARY

Embodiments of the present disclosure provide an information processing method for a radio link failure, a terminal, and a network device, to resolve the problem that an RLF between a terminal and an MCG triggers an RRC re-establishment process, and transmission that is being performed by the terminal needs to be suspended and user experience is affected.

To resolve the foregoing technical problem, the following technical solutions are used in the present disclosure:

According to a first aspect, an embodiment of the present disclosure provides an information processing method for a radio link failure, applied to a terminal, and including:
determining whether a first condition is met;
if the first condition is met, sending radio link failure information of a master serving cell group MCG to a secondary serving cell group SCG; and
receiving MCG reconfiguration information sent by the SCG, where
the first condition includes at least: a radio link failure occurs between the terminal and the MCG.

According to a second aspect, an embodiment of the present disclosure provides an information processing method for a radio link failure, applied to a secondary serving cell group SCG, and including:
receiving radio link failure information of a master serving cell group MCG that is sent by a terminal;
sending the radio link failure information of the MCG to the MCG;
obtaining MCG reconfiguration information; and
sending the MCG reconfiguration information to the terminal.

According to a third aspect, an embodiment of the present disclosure provides an information processing method for a radio link failure, applied to a master serving cell group MCG, and including:
receiving radio link failure information of the MCG that is sent by a secondary serving cell group SCG; and
sending MCG reconfiguration information to the SCG.

According to a fourth aspect, an embodiment of the present disclosure provides a terminal, including:
a determining module, configured to determine whether a first condition is met;
a first sending module, configured to: if the first condition is met, send radio link failure information of a master serving cell group MCG to a secondary serving cell group SCG; and
a first receiving module, configured to receive MCG reconfiguration information sent by the SCG, where
the first condition includes at least: a radio link failure occurs between the terminal and the MCG.

According to a fifth aspect, an embodiment of the present disclosure provides a terminal, including: a memory, a processor, and a computer program stored in the memory and executable on the processor, where the computer program, when executed by the processor, implements steps of the information processing method for a radio link failure.

According to a sixth aspect, an embodiment of the present disclosure provides a first network device, where the first network device includes a secondary serving cell group SCG, and includes:
a second receiving module, configured to receive radio link failure information of a master serving cell group MCG that is sent by a terminal;
a second sending module, configured to send the radio link failure information of the MCG to the MCG;
an obtaining module, configured to obtain MCG reconfiguration information; and
a third sending module, configured to send the MCG reconfiguration information to the terminal.

According to a seventh aspect, an embodiment of the present disclosure provides a first network device, the first network device includes a secondary serving cell group SCG, and includes: a memory, a processor, and a computer program stored in the memory and executable on the processor, where the computer program, when executed by the processor, implements steps of the information processing method for a radio link failure.

According to an eighth aspect, an embodiment of the present disclosure provides a second network device, where the second network device includes a master serving cell group MCG, and includes:
a third receiving module, configured to receive radio link failure information of the MCG that is sent by a secondary serving cell group SCG; and
a fourth sending module, configured to send MCG reconfiguration information to the SCG.

According to a ninth aspect, an embodiment of the present disclosure provides a second network device, the second network device includes a master serving cell group MCG, and includes: a memory, a processor, and a computer program stored in the memory and executable on the processor, where the computer program, when executed by the processor, implements steps of the information processing method for a radio link failure.

According to a tenth aspect, an embodiment of the present disclosure provides a computer-readable storage medium, storing a computer program, where the computer program, when executed by a processor, implements steps of the information processing method for a radio link failure.

The present disclosure has the following beneficial effects:

In the above solution, when it is determined that the first condition for sending the radio link failure information of the MCG is met, the radio link failure information of the MCG is sent to the SCG, and the MCG reconfiguration information sent by the SCG is received, to implement fast link recovery and avoid the problem that an RLF between the terminal and the MCG triggers an RRC re-establishment process, and transmission that is being performed by the terminal needs to be suspended for a long time. This can ensure rapid recovery of data transmission and improve user experience

### BRIEF DESCRIPTION OF DRAWINGS

FIG. 1 is a schematic flowchart of an information processing method for a radio link failure applied to a terminal according to an embodiment of the present disclosure;

FIG. 2 is a first schematic flowchart of an information processing method for a radio link failure according to an embodiment of the present disclosure;

FIG. 3 is a second schematic flowchart of an information processing method for a radio link failure according to an embodiment of the present disclosure;

FIG. 4 is a schematic diagram of modules of a terminal according to an embodiment of the present disclosure;

FIG. 5 is a structural block diagram of a terminal according to an embodiment of the present disclosure;

FIG. 6 is a schematic diagram of modules of a first network device according to an embodiment of the present disclosure;

FIG. 7 is a structural block diagram of a first network device according to an embodiment of the present disclosure.

FIG. 8 is a schematic diagram of modules of a second network device according to an embodiment of the present disclosure; and

FIG. 9 is a structural block diagram of a second network device according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings and specific embodiments.

Before the embodiments of the present disclosure are described, some concepts used in the following description are explained first.

In LTE and NR systems, UE detects whether an RLF occurs through a radio link monitor (Radio Link Monitor, RLM) function. After determining the RLF, the UE performs a corresponding link recovery process.

The RLM and the RLF are only performed in a PCell and a PScell.

The RLM and the RLF in a PCell:

In the RLM function of LTE, UE measures a signal to interference plus noise ratio (Signal to Interference plus Noise Ratio, SINR) of a cell reference signal (Cell Reference Signal, CRS) corresponding to a physical downlink control channel (Physical Downlink Control CHannel, PDCCH) of the PCell, to monitor a radio link. When a physical layer (L1) of the UE obtains through measurement that the SINR of the CRS corresponding to the PDCCH of the PCell is lower than a threshold, it is considered that the radio link is out of sync (“out of sync”). The physical layer notifies an upper layer (RRC layer, L3) of an out-of-sync indication. If the RRC layer continuously receives N310 out-of-sync indications, the RRC layer of the UE starts a timer (Timer) T310.

If the measured SINR of the CRS corresponding to the PDCCH of the PCell is higher than a threshold, it is considered that the radio link is in sync (“in sync”). In this case, the physical layer notifies the upper layer (RRC layer) of an in-sync indication. If the RRC layer continuously receives N311 in-sync indications, the UE stops the operation of the Timer T310.

If the Timer T310 expires, the UE determines the RLF and starts the Timer T311. During the operation of T311, the UE tries to find a suitable cell for RRC connection re-establishment. Before re-establishment succeeds, exchange of user-plane data between the UE and a network is suspended.

If the UE does not succeed in re-establishment before T311 expires, the UE switches from an RRC connected state (RRC_CONNECTED) to an RRC idle state (RRC_IDLE).

Duration of N310, N311, T310, and T311 is configured by the network.

The RLM process of NR is similar to that of LTE. In NR, an RLM RS detected by a PCell is configured by the network.

The present disclosure provides an information processing method for a radio link failure, a terminal, and a network device, to resolve the problem that an RLF between a terminal and an MCG triggers an RRC re-establishment process, and transmission that is being performed by the terminal needs to be suspended and user experience is affected.

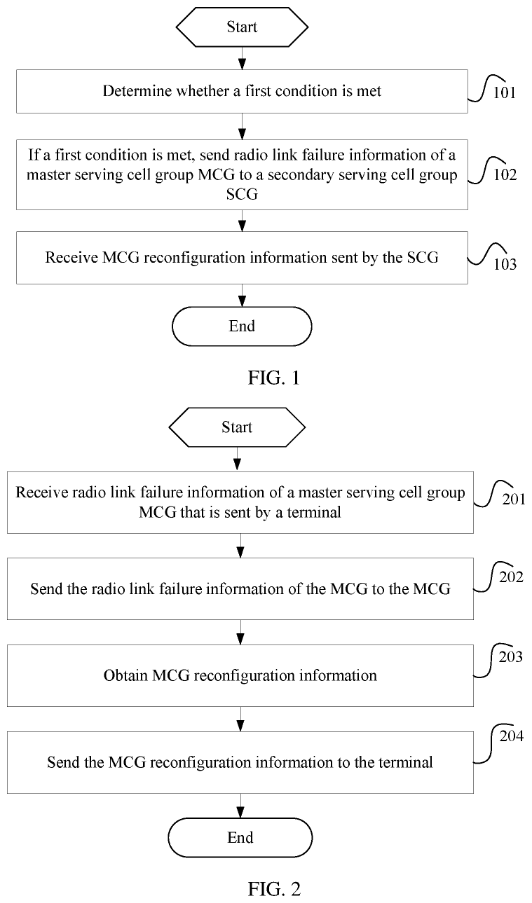

As shown in FIG. 1, an embodiment of the present disclosure provides an information processing method for a radio link failure, applied to a terminal, and including:

Step 101: Determine whether a first condition is met.

It should be noted that the first condition includes at least: a radio link failure occurs between the terminal and the MCG.

Step 102: If the first condition is met, send radio link failure information of a master serving cell group MCG to a secondary serving cell group SCG.

Step 103: Receive MCG reconfiguration information sent by the SCG.

It should be noted that when it is determined that a radio link failure occurs between the terminal and the MCG, the MCG reconfiguration information sent by the SCG is received, to implement fast link recovery and avoid the problem that an RLF between the terminal and the MCG triggers an RRC re-establishment process, and transmission that is being performed by the terminal needs to be suspended for a long time. This can ensure rapid recovery of data transmission and improve user experience

It should be noted that in the process of determining whether the first condition for sending the radio link failure information of the MCG is met, the terminal may monitor a physical downlink control channel (PDCCH), or the terminal may not monitor a PDCCH. The specific behavior of the terminal is described from these two perspectives as follows:

1. The terminal does not monitor a PDCCH

The following is a detailed description of this situation.

Specifically, when the radio link failure occurs between the terminal and the MCG, the information processing method for a radio link failure further includes at least one of the following steps:
suspending transmission of a data radio bearer (DRB);
suspending transmission of a signaling radio bearer (SRB); or
stopping monitoring at least one PDCCH of the MCG.

It should be noted that when the radio link failure occurs between the terminal and the MCG, the terminal suspends transmission of a DRB and transmission of an SRB, and stops monitoring at least one PDCCH of the MCG. Transmission of the DRB includes: at least one of at least one MCG DRB, an MCG part of at least one MCG split DRB (MCG part of MCG split DRB), or an MCG part of at least one SCG split DRB (MCG part of SCG split DRB). Transmission of the SRB includes: at least one of at least one MCG signaling radio bearer 1, at least one MCG signaling radio bearer 2, an MCG part of at least one MCG split signaling radio bearer 1 (MCG part of MCG split SRB1), and an MCG part of at least one MCG split signaling radio bearer 2 (MCG part of MCG split SRB2). The at least one PDCCH includes at least one of the following information: a PDCCH of a master serving cell; or a PDCCH of at least one secondary serving cell.

Further, it should be noted that in this case, when it is determined that a radio link failure occurs between the terminal and the master serving cell group MCG, the terminal sends the radio link failure information of the MCG to the SCG. Specifically, the radio link failure information of the MCG is sent through a preset bearer.

The preset bearer includes: at least one of an SCG part of an MCG signaling split radio bearer 1 (SCG part of MCG split SRB1) or an SCG signaling radio bearer 3 (SCG SRB3).

After the terminal sends the radio link failure information of the MCG to the SCG, the SCG forwards the radio link failure information of the MCG to the MCG, then the MCG sends the MCG reconfiguration information to the SCG, and finally the SCG forwards the MCG reconfiguration information to the terminal. It should be noted that the MCG sends the MCG reconfiguration information to the SCG through an SCG part of an MCG split signaling radio bearer 1 (SCG part of MCG split SRB1) or an Xn interface between the MCG and the SCG, and then the SCG forwards the MCG reconfiguration information to the terminal.

In this case, an actual execution process of the terminal is as follows:

When the terminal determines that a radio link failure occurs between the terminal and the MCG, the terminal suspends transmission of a DRB and transmission of an SRB, does not monitor at least one PDCCH of the MCG, and directly sends the radio link failure information of the MCG to the SCG.

2. The terminal monitors a PDCCH

The following is a detailed description of this situation.

Specifically, when the radio link failure occurs between the terminal and the MCG, the information processing method for a radio link failure further includes at least one of the following manners:
suspending transmission of a DRB;
suspending transmission of an SRB; or
monitoring at least one PDCCH of the MCG.

It should be noted that when it is determined that the radio link failure occurs between the terminal and the MCG, the terminal suspends transmission of a DRB and transmission of an SRB, and monitors at least one PDCCH of the MCG. Transmission of the DRB includes: at least one of at least one MCG DRB, an MCG part of at least one MCG split DRB, or an MCG part of at least one SCG split DRB. Transmission of the SRB includes: at least one of at least one MCG signaling radio bearer 1, at least one MCG signaling radio bearer 2, an MCG part of at least one MCG split signaling radio bearer 1, and an MCG part of at least one MCG split signaling radio bearer 2. The at least one PDCCH includes at least one of the following information: a PDCCH of a master serving cell; or a PDCCH of at least one secondary serving cell.

Specifically, in this case, the first condition further includes at least one of the following information:
a radio link is not recovered; or
no contention random access channel indication is detected, where
the contention random access channel indication is triggered by downlink control information in a PDCCH.

It should be noted that when monitoring a PDCCH, the terminal may determine, within the timing duration of the first timer, whether the radio link is recovered. If the radio link is not recovered, it indicates that the first condition for sending the radio link failure information of the MCG is met. It should be noted that if the terminal has not determined, when the timing duration of the first timer is exceeded, whether the radio link is recovered, the radio link failure information of the MCG is sent. The terminal may determine whether a content random access channel indication is detected. If the content random access channel indication is not detected, it indicates that the first condition for sending the radio link failure information of the MCG is met.

Further, it should be noted that the terminal specifically determines, in the following manner, whether a radio link is recovered:
running a first timer; specifically, running the first timer means starting the first timer or restarting the first timer.
during running of the first timer, when a physical layer synchronization indication count value is greater than or equal to a first physical layer synchronization indication count threshold, determining that a radio link recovers, and stopping running the first timer; and
when running of the first timer expires (that is, timing duration is exceeded), determining that a radio link cannot be recovered.

It should be noted that the first timer is a timer used in a process of determining whether the radio link is recovered.

It should also be noted that before performing the above steps, the terminal needs to obtain the timing duration of the first timer and the first physical layer synchronization indication count threshold. Specifically, the timing duration of the first timer is configured by using at least one of the following information: a broadcast message, radio resource control (RRC) signaling, and protocol stipulation. The first physical layer synchronization indication count threshold is configured by using at least one of the following information: a broadcast message, RRC signaling, and protocol stipulation.

It should be noted that when the timing duration of the first timer (or the first physical layer synchronization indication count threshold) is configured by using the broadcast message or the RRC signaling, the timing duration of the first timer (or the first physical layer synchronization indication count threshold) is sent to the terminal by the MCG through the broadcast message or the RRC signaling when the terminal and MCG are in a communication state.

It should also be noted that in this case, the terminal may or may not send the radio link failure information of the MCG. Therefore, before sending the radio link failure information of the MCG to the secondary serving cell group SCG, the method further includes:
generating the radio link failure information of the MCG.

It should be noted that the radio link failure information of the MCG is to-be-sent radio link failure information of the MCG. That is, after the to-be-sent radio link failure information of the MCG is generated, the to-be-sent radio link failure information of the MCG is not sent to the SCG. Only when the first condition for sending the radio link failure information of the MCG is met (that is, a radio link is not recovered and/or the contention random access channel indication is not detected), the radio link failure information of the MCG is sent to the SCG. If a radio link recovers and/or the contention random access channel indication is detected, the radio link failure information of the MCG is not sent (that is, the to-be-sent radio link failure information of the MCG is canceled).

In this case, an actual execution process of the terminal is as follows:

When the terminal determines that a radio link failure occurs between the terminal and the MCG, the terminal suspends transmission of a DRB and transmission of an SRB, monitors at least one PDCCH of the MCG, and generates the to-be-sent radio link failure information of the MCG. At the same time, the terminal performs the follow-up process in one of the following manners:

Manner 1: The radio link is monitored again when at least one PDCCH of the MCG is monitored, to determine whether the radio link is recovered. When it is determined that the radio link is recovered again, reporting of the radio link failure information of the MCG to the SCG is canceled (that is, the radio link failure information of the MCG is not sent to the SCG). If the terminal determines that the radio link cannot be recovered again, the terminal reports the radio link failure information of the MCG to SCG (that is, the radio link failure information of the MCG is sent to the SCG).

Manner 2: When the terminal detects, when at least one PDCCH of the MCG is monitored, a contention random access channel (RACH) indication triggered by downlink control information in a PDCCH, the terminal cancels reporting of the radio link failure information of the MCG to the SCG (that is, the radio link failure information of the MCG is not sent to the SCG) and initiates the RACH process. When the terminal has not detected the RACH indication triggered by the downlink control information in the PDCCH, the terminal reports the radio link failure information of the MCG to the SCG (that is, the radio link failure information of the MCG is sent to the SCG).

After the terminal sends the radio link failure information of the MCG to the SCG, the SCG forwards the radio link failure information of the MCG to the MCG, then the MCG sends the MCG reconfiguration information to the SCG, and finally the SCG forwards the MCG reconfiguration information to the terminal.

It should be noted that the embodiments of the present disclosure may be mainly applied to dual-connection scenarios. Further, the embodiments of the present disclosure may be extended to multi-connection scenarios.

In the embodiments of the present disclosure, initiation of an RRC connection re-establishment process by the terminal is avoided, the SCG is used to recover a radio link, and the terminal processes the MCG to reduce suspenions of data receiving and sending of the terminal as much as possible.

Specifically, as shown in FIG. 2, FIG. 2 is a schematic flowchart of an information processing method for a radio link failure according to an embodiment of the present disclosure. The information processing method for a radio link failure is applied to an SCG, and includes:

Step 201: Receive radio link failure information of a master serving cell group MCG that is sent by a terminal.

Step 202: Send the radio link failure information of the MCG to the MCG.

Step 203: Obtain MCG reconfiguration information.

Step 204: Send the MCG reconfiguration information to the terminal.

Further, a specific implementation of the step 203 is as follows:
receiving the MCG reconfiguration information sent by the MCG in a preset manner, where
the preset manner includes: at least one of an SCG part of an MCG split signaling radio bearer 1 or an Xn interface between the MCG and the SCG.

It should be noted that all the descriptions about the SCG in the foregoing embodiments are applicable to the embodiment of the information processing method for a radio link failure, and the same technical effect thereof can be achieved.

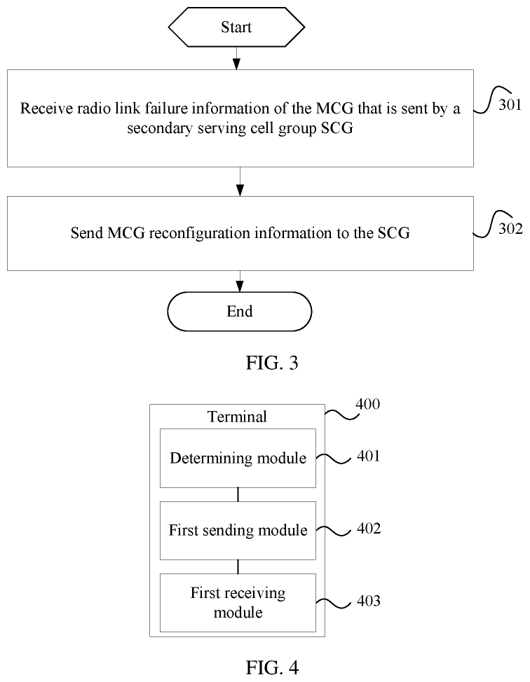

Specifically, as shown in FIG. 3, FIG. 3 is a schematic flowchart of an information processing method for a radio link failure according to an embodiment of the present disclosure. The information processing method for a radio link failure is applied to an MCG, and includes:

Step 301: Receive radio link failure information of the MCG that is sent by a secondary serving cell group SCG.

Step 302: Send MCG reconfiguration information to the SCG.

Specifically, an implementation of the step 302 is as follows:
sending the MCG reconfiguration information to the SCG in a preset manner, where
the preset manner includes: at least one of an SCG part of an MCG split signaling radio bearer 1 or an Xn interface between the MCG and the SCG.

Further, before step 301, the method further includes:
sending timing duration of a first timer and/or a first physical layer synchronization indication count threshold to the terminal by using a target message, where
the target message includes: at least one of a broadcast message or radio resource control RRC signaling

It should be noted that when the terminal and MCG are connected (that is, the terminal can communicate directly with the MCG), the MCG directly sends the target message to the terminal.

It should be noted that all the descriptions about the MCG in the foregoing embodiments are applicable to the embodiment of the information processing method for a radio link failure, and the same technical effect thereof can be achieved.

Referring to FIG. 4, an embodiment of the present disclosure provides a terminal 400, including:
a determining module 401, configured to determine whether a first condition is met;
a first sending module 402, configured to: if the first condition is met, send radio link failure information of a master serving cell group MCG to a secondary serving cell group SCG; and
a first receiving module 403, configured to receive MCG reconfiguration information sent by the SCG, where
the first condition includes at least: a radio link failure occurs between the terminal and the MCG.

Specifically, when the radio link failure occurs between the terminal and the MCG, the terminal further includes at least one of the following modules:
a first execution module, configured to suspend transmission of a data radio bearer DRB;
a second execution module, configured to suspend transmission of a signaling radio bearer SRB; or
a third execution module, configured to stop monitoring at least one physical downlink control channel PDCCH of the MCG.

Specifically, when the radio link failure occurs between the terminal and the MCG, the terminal further includes at least one of the following modules:
a fourth execution module, configured to suspend transmission of a DRB;
a fifth execution module, configured to suspend transmission of an SRB; or
a sixth execution module, configured to monitor at least one PDCCH of the MCG.

Optionally, the first condition further includes at least one of the following information:
a radio link is not recovered; or
no contention random access channel indication is detected, where
the contention random access channel indication is triggered by downlink control information in a PDCCH.

Further, when the terminal monitors at least one PDCCH of the MCG, the terminal further includes:
a running module, configured to run a first timer;
a first determining module, configured to: during running of the first timer, when a physical layer synchronization indication count value is greater than or equal to a first physical layer synchronization indication count threshold, determine that a radio link recovers, and stopping running the first timer; and
a second determining module, configured to: when running of the first timer expires, determine that a radio link cannot be recovered.

Specifically, timing duration of the first timer is configured by using at least one of the following information:
a broadcast message, a radio resource control RRC signaling, and protocol stipulation.

Specifically, the first the physical layer synchronization indication count threshold is configured by using at least one of the following information:
a broadcast message, a radio resource control RRC signaling, and protocol stipulation.

Alternatively, on the basis that the first condition further includes: a radio link is not recovered and/or the contention random access channel indication is not detected, the terminal further includes:
a seventh execution module, configured to: if a radio link is recovered and/or detecting a contention random access channel indication, skip sending the radio link failure information of the MCG.

Optionally, before the first sending module 402 sends the radio link failure information of the MCG to the secondary serving cell group SCG, the terminal further includes:
an eighth execution module, configured to generate the radio link failure information of the MCG.

Specifically, the at least one PDCCH includes at least one of the following information:
a PDCCH of a master serving cell; or
a PDCCH of at least one secondary serving cell.

Specifically, transmission of the DRB includes: at least one of at least one MCG DRB, an MCG part of at least one MCG split DRB, or an MCG part of at least one SCG split DRB.

Specifically, transmission of the SRB includes: at least one of at least one MCG signaling radio bearer 1, at least one MCG signaling radio bearer 2, an MCG part of at least one MCG split signaling radio bearer 1, and an MCG part of at least one MCG split signaling radio bearer 2.

Specifically, the radio link failure information of the MCG is sent by using a preset bearer; and
the preset bearer includes: at least one of an SCG part of an MCG split radio bearer 1 or an SCG signaling radio bearer 3.

It should be noted that this embodiment of the terminal provides the terminal corresponding to the information processing method for a radio link failure applied to the terminal, all implementations in the foregoing embodiments are applicable to this terminal embodiment, and the same technical effect thereof can be achieved.

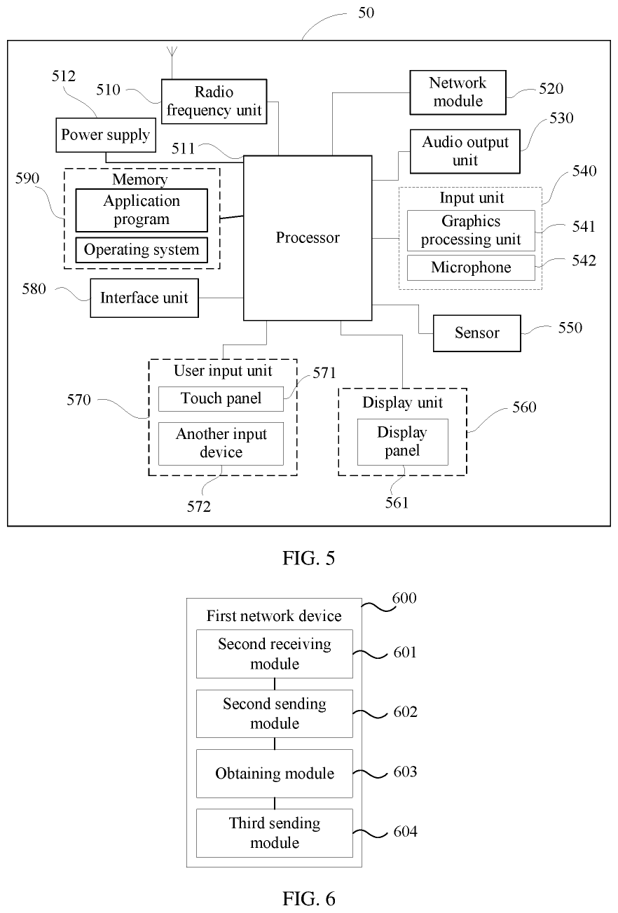

FIG. 5 is a schematic diagram of a hardware structure of a terminal according to an embodiment of the present disclosure.

The terminal 50 includes, but is not limited to: a radio frequency unit 510, a network module 520, an audio output unit 530, an input unit 540, a sensor 550, a display unit 560, a user input unit 570, an interface unit 580, a memory 590, a processor 511 and a power supply 512. It can be understood by those skilled in the art that the structure of the terminal shown in FIG. 5 does not constitute a limitation on the terminal, and the terminal may include more or fewer components than those shown in the figure, or combine some components, or have different component arrangements. In the embodiments of the present disclosure, the terminal includes, but is not limited to, a mobile phone, a tablet computer, a notebook computer, a palmtop computer, a vehicle-mounted terminal, a wearable device, a pedometer, or the like.

The processor 511 is configured to determine whether a first condition is met; if the first condition is met, send radio link failure information of a master serving cell group MCG to a secondary serving cell group SCG; and receive MCG reconfiguration information sent by the SCG, where
the first condition includes at least: a radio link failure occurs between the terminal and the MCG.

When the terminal in the embodiments of the present disclosure determines that the first condition for sending the radio link failure information of the MCG is met, the radio link failure information of the MCG is sent to the SCG, and the MCG reconfiguration information sent by the SCG is received, to implement fast link recovery and avoid the problem that an RLF between the terminal and the MCG triggers an RRC re-establishment process, and transmission that is being performed by the terminal needs to be suspended for a long time. This can ensure rapid recovery of data transmission and improve user experience

It should be understood that, in this embodiment of the present disclosure, the radio frequency unit 510 can be configured to receive and transmit signals during information receiving and sending or a call. Specifically, the radio frequency unit 510 receives downlink data from a network device, and transmits the downlink data to the processor 511 for processing; and in addition, transmits uplink data to the network device. Generally, the radio frequency unit 510 includes but is not limited to an antenna, at least one amplifier, a transceiver, a coupler, a low noise amplifier, a duplexer, and the like. In addition, the radio frequency unit 510 may also communicate with another device through a wireless communications system and network.

The terminal provides wireless broadband Internet access for a user by using the network module 520, for example, helps the user send and receive an email, browse a web page, and access streaming media.

The audio output unit 530 can convert audio data received by the radio frequency unit 510 or the network module 520 or stored in the memory 590 into an audio signal, and output the audio signal into sound. In addition, the audio output unit 530 can also provide audio output related to a specific function performed by the terminal 50 (for example, call signal receiving sound or message receiving sound). The audio output unit 530 includes a speaker, a buzzer, a telephone receiver, and the like.

The input unit 540 is configured to receive audio or video signals. The input unit 540 may include a graphics processing unit (Graphics Processing Unit, GPU) 541 and a microphone 542. The graphics processing unit 541 processes image data of a static image or a video obtained by an image capturing apparatus (such as, a camera) in a video capturing mode or an image capturing mode. A processed image frame may be displayed on the display unit 560. The image frame processed by the graphics processing unit 541 can be stored in the memory 590 (or another storage medium) or sent via the radio frequency unit 510 or the network module 520. The microphone 542 may receive sound and can process such sound into audio data. Processed audio data can be converted, in telephone call mode, into a format that can be sent to a mobile communication network device via the radio frequency unit 510 for output.

The terminal 50 further includes at least one sensor 550, such as a light sensor, a motion sensor, and other sensors. Specifically, the light sensor includes an ambient light sensor and a proximity sensor, where the ambient light sensor can adjust brightness of the display panel 561 based on brightness of ambient light, and the proximity sensor can turn off the display panel 561 and/or backlight when the terminal 50 moves towards the ear. As a type of motion sensor, an accelerometer sensor can detect the magnitude of acceleration in various directions (usually three axes) and detect the magnitude and the direction of gravity when stationary, and can be configured to identify terminal postures (such as switching between a portrait mode and a landscape mode, related games, and magnetometer posture calibration), and perform functions related to vibration identification (such as a pedometer and a knock), and the like. The sensor 550 may further include a fingerprint sensor, a pressure sensor, an iris sensor, a molecular sensor, a gyroscope, a barometer, a hygrometer, a thermometer, an infrared sensor, or the like. Details are not described herein.

The display unit 560 is configured to display information entered by a user or information provided for the user. The display unit 560 may include a display panel 561, and the display panel 561 may be configured in a form of liquid crystal display (Liquid Crystal Display, LCD), organic light-emitting diode (Organic Light-Emitting Diode, OLED), or the like.

The user input unit 570 may be configured to receive inputted digit or character information and generate key signal input related to user setting and function control of the terminal. Specifically, the user input unit 570 includes a touch panel 571 and another input device 572. The touch panel 571 is also referred to as a touchscreen, and may collect a touch operation performed by a user on or near the touch panel 571 (such as an operation performed by a user on the touch panel 571 or near the touch panel 571 by using any proper object or accessory, such as a finger or a stylus). The touch panel 571 may include two parts: a touch detection apparatus and a touch controller. The touch detection apparatus detects a touch location of the user, detects a signal carried by a touch operation, and transmits the signal to the touch controller. The touch controller receives touch information from the touch detection apparatus, converts the touch information to point coordinates, and sends the point coordinates to the processor 511, and receives and executes a command sent by the processor 511. In addition, the touch panel 571 may be implemented in various types such as resistive, capacitive, infrared, and surface acoustic wave. In addition to the touch panel 571, the user input unit 570 may further include the another input device 572. Specifically, the another input device 572 may include but is not limited to one or more of a physical keyboard, a function key (such as a volume control key or an on/off key), a trackball, a mouse, a joystick, and the like. Details are not described herein.

Further, the touch panel 571 can cover the display panel 561. When detecting a touch operation on or near the touch panel 571, the touch panel 571 transmits the touch operation to the processor 511 to determine a type of a touch event. Then, the processor 511 provides corresponding visual output on the display panel 561 based on the type of the touch event. In FIG. 5, the touch panel 571 and the display panel 561 are used as two independent components to implement input and output functions of the terminal. However, in some embodiments, the touch panel 571 and the display panel 561 may be integrated to implement the input and output functions of the terminal. This is not specifically limited herein.

The interface unit 580 is an interface connecting an external apparatus to the terminal 50. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, and a headset port. The interface unit 580 may be configured to receive input (for example, data information and power) from an external apparatus and transmit the received input to one or more elements within the terminal 50, or may be configured to transmit data between the terminal 50 and the external apparatus.

The memory 590 may be configured to store software programs and various data. The memory 590 may mainly include a program storage area and a data storage area. The program storage area may store an operating system, an application program required by at least one function (such as a sound playback function and an image playback function), and the like. The data storage area may store data (such as audio data and an address book) created based on the use of the mobile phone, and the like. In addition, the memory 590 may include a high-speed random access memory or a nonvolatile memory, for example, at least one magnetic disk storage device, a flash memory, or another volatile solid-state storage device.

The processor 511 is a control center of the terminal, connects various parts of the entire terminal by using various interfaces and circuits, and performs various functions of the terminal and processes data by running or executing software programs and/or modules stored in the memory 590 and invoking data stored in the memory 590, so as to monitor the terminal as a whole. The processor 511 may include one or more processing units. Optionally, the processor 511 may integrate an application processor and a modem processor. The application processor mainly deals with an operating system, a user interface, an application program, and the like. The modem processor mainly deals with wireless communication. It may be understood that alternatively, the modem processor may not be integrated into the processor 511.

The terminal 50 may further include a power supply 512 (such as a battery) that supplies power to each component. Optionally, the power supply 512 may be logically connected to the processor 511 by using a power management system, to implement functions such as charging, discharging, and power consumption management by using the power management system.

In addition, the terminal 50 includes some function modules not shown, and details are not described herein again.

Optionally, an embodiment of the present disclosure further provides a terminal, including a processor 511, a memory 590, and a computer program stored in the memory 590 and executable on the processor 511. When the computer program is executed by the processor 511, each process of the embodiment of the information processing method for a radio link failure applied to a terminal side is implemented, and a same technical effect can be achieved. To avoid repetition, details are not described herein again.

An embodiment of the present disclosure further provides a computer-readable storage medium, where the computer-readable storage medium stores a computer program. The computer program, when executed by a processor, implements each process of the embodiment of the information processing method for a radio link failure, and the same technical effect can be achieved. To avoid repetition, details are not described herein again. The computer-readable storage medium is, for example, a read-only memory (Read-Only Memory, ROM for short), a random access memory (Random Access Memory, RAM for short), a magnetic disk, or an optical disk.

As shown in FIG. 6, an embodiment of the present disclosure further provides a first network device 600. The first network device includes a secondary serving cell group SCG, and includes:
a second receiving module 601, configured to receive radio link failure information of a master serving cell group MCG sent by a terminal;
a second sending module 602, configured to send the radio link failure information of the MCG to the MCG;
an obtaining module 603, configured to obtain MCG reconfiguration information; and
a third sending module 604, configured to send the MCG reconfiguration information to the terminal.

Optionally, the obtaining module 603 is configured to:
receive the MCG reconfiguration information sent by the MCG in a preset manner, where
the preset manner includes: at least one of an SCG part of an MCG split signaling radio bearer 1 or an Xn interface between the MCG and the SCG.

It should be noted that this embodiment of the first network device provides the first network device corresponding to the information processing method for a radio link failure applied to the SCG, all implementations in the foregoing embodiments are applicable to this embodiment of the first network device, and the same technical effect thereof can be achieved.

An embodiment of the present disclosure further provides a first network device, including: a memory, a processor, and a computer program stored in the memory and executable on the processor. The computer program, when executed by the processor, implements processes in the embodiment of the information processing method for a radio link failure applied to the SCG, and the same technical effect can be achieved. To avoid repetition, details are not described herein again.

An embodiment of the present disclosure further provides a computer-readable storage medium, where the computer-readable storage medium stores a computer program, the computer program, when executed by the processor, implements the processes of the foregoing embodiments of the information processing method for a radio link failure applied to the SCG, and the same technical effects can be achieved. To avoid repetition, details are not described herein again. The computer-readable storage medium may be a read-only memory (Read-Only Memory, ROM for short), a random access memory (Random Access Memory, RAM for short), a magnetic disk, a compact disc, or the like.

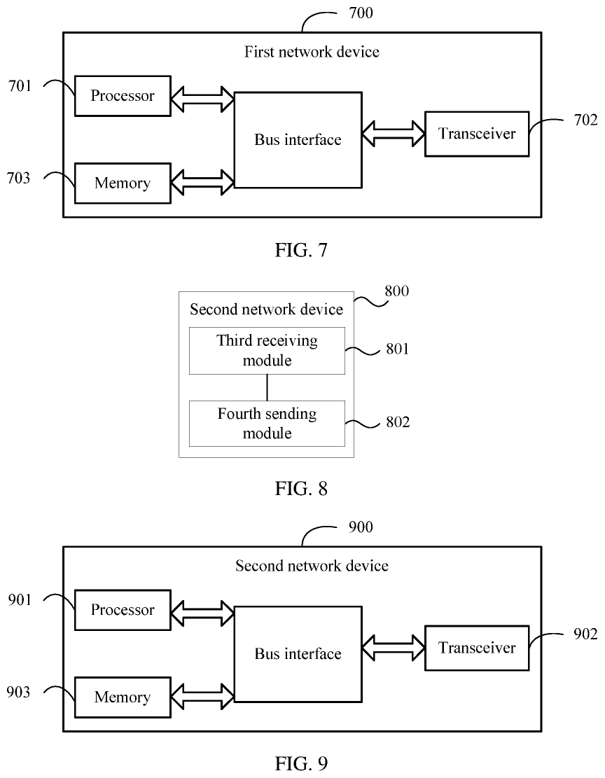

FIG. 7 is a structural diagram of a first network device according to an embodiment of the present disclosure. The first network device can implement details of the information processing method for a radio link failure, and achieve the same effect. As shown in FIG. 7, the network device 700 includes: a processor 701, a transceiver 702, a memory 703, and a bus interface.

The processor 701 is configured to read a program in the memory 703 to perform the following process:

The transceiver 702 receives radio link failure information of a master serving cell group MCG sent by a terminal; sends the radio link failure information of the MCG to the MCG; obtains MCG reconfiguration information; and sends the MCG reconfiguration information to the terminal.

In FIG. 7, the bus architecture may include any quantity of interconnected buses and bridges, which are specifically connected together by various circuits of one or more processors represented by the processor 701 and a memory represented by the memory 703. The bus architecture may further connect together various other circuits of a peripheral device, a voltage stabilizer, a power management circuit, and the like, which are known in this art and will not be further described herein. The bus interface provides an interface. The transceiver 702 may include a plurality of elements, that is, include a transmitter and a receiver, and provide units for communication with various other apparatuses on a transmission medium.

The processor 701 is responsible for managing the bus architecture and common processing, and the memory 703 may store data used when the processor 701 performs an operation.

Optionally, the processor 701 is configured to read a program in the memory 703 to perform the following process:
receiving, by using the transceiver 702, MCG reconfiguration information sent by the MCG in a preset manner, where
the preset manner includes: at least one of an SCG part of an MCG split signaling radio bearer 1 or an Xn interface between the MCG and the SCG.

The first network device may be a base transceiver station (Base Transceiver Station, BTS for short) in global system for mobile communications (Global System of Mobile communication, GSM for short) or code division multiple access (Code Division Multiple Access, CDMA for short), or may be a NodeB (NodeB, NB for short) in wideband code division multiple access (Wideband Code Division Multiple Access, WCDMA for short), or may be an evolved NodeB (Evolutional NodeB, eNB or eNodeB for short) in LTE, or a relay station or an access point, or a base station in the future 5G network. This is not limited herein.

As shown in FIG. 8, an embodiment of the present disclosure further provides a second network device 800. The second network device includes a master serving cell group MCG, and includes:
a third receiving module 801, configured to receive radio link failure information of the MCG that is sent by a secondary serving cell group SCG; and
a fourth sending module 802, configured to send MCG reconfiguration information to the SCG.

Specifically, the fourth sending module 802 is configured to:
send the MCG reconfiguration information to the SCG in a preset manner, where
the preset manner includes: at least one of an SCG part of an MCG split signaling radio bearer 1 or an Xn interface between the MCG and the SCG.

Optionally, before the third receiving module 801 receives the radio link failure information of the MCG that is sent by the secondary serving cell group SCG, the second network device further includes:
a fifth sending module, configured to send timing duration of a first timer and/or a first physical layer synchronization indication count threshold to the terminal by using a target message, where
the target message includes: at least one of a broadcast message or radio resource control RRC signaling

It should be noted that this embodiment of the second network device provides the second network device corresponding to the information processing method for a radio link failure applied to the MCG, all implementations in the foregoing embodiments are applicable to this embodiment of the second network device, and the same technical effect thereof can be achieved.

An embodiment of the present disclosure further provides a second network device, including: a memory, a processor, and a computer program stored in the memory and executable the processor. The computer program, when executed by the processor, implements processes in the embodiment of the information processing method for a radio link failure applied to the MCG, and the same technical effect can be achieved. To avoid repetition, details are not described herein again.

An embodiment of the present disclosure further provides a computer-readable storage medium, where the computer-readable storage medium stores a computer program, the computer program, when executed by the processor, implements the processes of the foregoing embodiments of the information processing method for a radio link failure applied to the MCG, and the same technical effects can be achieved. To avoid repetition, details are not described herein again. The computer-readable storage medium may be a read-only memory (Read-Only Memory, ROM for short), a random access memory (Random Access Memory, RAM for short), a magnetic disk, a compact disc, or the like.

FIG. 9 is a structural diagram of a second network device according to an embodiment of the present disclosure. The second network device can implement details of the information processing method for a radio link failure, and achieve the same effect. As shown in FIG. 9, the network device 900 includes: a processor 901, a transceiver 902, a memory 903, and a bus interface.

The processor 901 is configured to read a program in the memory 903 to perform the following process:
receiving, by using the transceiver 902, radio link failure information of the MCG that is sent by a secondary serving cell group SCG; and sending MCG reconfiguration information to the SCG.

In FIG. 9, the bus architecture may include any quantity of interconnected buses and bridges, which are specifically connected together by various circuits of one or more processors represented by the processor 901 and a memory represented by the memory 903. The bus architecture may further connect together various other circuits of a peripheral device, a voltage stabilizer, a power management circuit, and the like, which are known in this art and will not be further described herein. The bus interface provides an interface. The transceiver 902 may include a plurality of elements, that is, include a transmitter and a receiver, and provide units for communication with various other apparatuses on a transmission medium.

The processor 901 is responsible for managing the bus architecture and common processing, and the memory 903 may store data used when the processor 901 performs an operation.

Optionally, the processor 901 is configured to read a program in the memory 903 to perform the following process:
sending MCG reconfiguration information to SCG in a preset manner by using the transceiver 902, where
the preset manner includes: at least one of an SCG part of an MCG split signaling radio bearer 1 or an Xn interface between the MCG and the SCG.

Optionally, the processor 901 is configured to read a program in the memory 903 to perform the following process:
sending timing duration of a first timer and/or a first physical layer synchronization indication count threshold to the terminal by using a target message and by using the transceiver 902, where
the target message includes: at least one of a broadcast message or radio resource control RRC signaling.

The second network device may be a base transceiver station (Base Transceiver Station, BTS for short) in global system for mobile communications (Global System of Mobile communication, GSM for short) or code division multiple access (Code Division Multiple Access, CDMA for short), or may be a NodeB (NodeB, NB for short) in wideband code division multiple access (Wideband Code Division Multiple Access, WCDMA for short), or may be an evolved NodeB (Evolutional NodeB, eNB or eNodeB for short) in LTE, or a relay station or an access point, or a base station in the future 5G network. This is not limited herein.

The optional implementations of the present disclosure are described above. It should be noted that persons of ordinary skill in the art may further make several improvements and refinements without departing from the principles described in the present disclosure, and these improvements and refinements also fall within the protection scope of the present disclosure.

1. An information processing method for a radio link failure, applied to a terminal, and comprising:
determining whether a first condition is met;
if the first condition is met, sending radio link failure information of a master serving cell group MCG to a secondary serving cell group SCG; and
receiving MCG reconfiguration information sent by the SCG, wherein
the first condition comprises at least: a radio link failure occurs between the terminal and the MCG.

2. The information processing method for a radio link failure according to claim 1, wherein when the radio link failure occurs between the terminal and the MCG, the information processing method for a radio link failure further comprises at least one of the following steps:
suspending transmission of a data radio bearer DRB;
suspending transmission of a signaling radio bearer SRB; or
stop monitoring at least one physical downlink control channel PDCCH of the MCG.

3. The information processing method for a radio link failure according to claim 1, wherein when the radio link failure occurs between the terminal and the MCG, the information processing method for a radio link failure further comprises at least one of the following manners:
suspending transmission of a DRB;
suspending transmission of an SRB; or
monitoring at least one PDCCH of the MCG.

4. The information processing method for a radio link failure according to claim 1, wherein the first condition further comprises at least one of the following information:
a radio link is not recovered; or
no contention random access channel indication is detected, wherein
the contention random access channel indication is triggered by downlink control information in a PDCCH.

5. The information processing method for a radio link failure according to claim 4, wherein when the terminal monitors at least one PDCCH of the MCG, the information processing method for a radio link failure further comprises:
running a first timer;
during running of the first timer, when a physical layer synchronization indication count value is greater than or equal to a first physical layer synchronization indication count threshold, determining that a radio link recovers, and stopping running the first timer; and
when running of the first timer expires, determining that a radio link cannot be recovered.

6. The information processing method for a radio link failure according to claim 5, wherein timing duration of the first timer is configured by using at least one of the following information:
a broadcast message, a radio resource control RRC signaling, or protocol stipulation.

7. The information processing method for a radio link failure according to claim 5, wherein the first the physical layer synchronization indication count threshold is configured by using at least one of the following information:
a broadcast message, a radio resource control RRC signaling, or protocol stipulation.

8. The information processing method for a radio link failure according to claim 4, further comprising:
if a radio link is recovered and/or detecting a contention random access channel indication, skipping sending the radio link failure information of the MCG.

9. The information processing method for a radio link failure according to claim 4, before the sending radio link failure information of a master serving cell group MCG to a secondary serving cell group SCG, further comprising:
generating the radio link failure information of the MCG.

10. The information processing method for a radio link failure according to claim 2, wherein the at least one PDCCH comprises at least one of the following information:
a PDCCH of a master serving cell; or
a PDCCH of at least one secondary serving cell.

11. The information processing method for a radio link failure according to claim 2, wherein transmission of the DRB comprises: at least one of at least one MCG DRB, an MCG part of at least one MCG split DRB, or an MCG part of at least one SCG split DRB.

12. The information processing method for a radio link failure according to claim 2, wherein transmission of the SRB comprises: at least one of at least one MCG signaling radio bearer 1, at least one MCG signaling radio bearer 2, an MCG part of at least one MCG split signaling radio bearer 1, or an MCG part of at least one MCG split signaling radio bearer 2.

13. The information processing method for a radio link failure according to claim 1, wherein the radio link failure information of the MCG is sent by using a preset bearer; and
the preset bearer comprises: at least one of an SCG part of an MCG split radio bearer 1 or an SCG signaling radio bearer 3.

14. A terminal, comprising: a memory, a processor, and a computer program stored in the memory and executable on the processor, wherein the computer program is executed by the processor to perform:
determining whether a first condition is met;
if the first condition is met, sending radio link failure information of a master serving cell group MCG to a secondary serving cell group SCG; and
receiving MCG reconfiguration information sent by the SCG, wherein
the first condition comprises at least: a radio link failure occurs between the terminal and the MCG.

15. The terminal according to claim 14, wherein when the radio link failure occurs between the terminal and the MCG, the computer program is executed by the processor to perform at least one of the following steps:
suspending transmission of a data radio bearer DRB;
suspending transmission of a signaling radio bearer SRB; or
stop monitoring at least one physical downlink control channel PDCCH of the MCG.

16. The terminal according to claim 15, wherein transmission of the DRB comprises: at least one of at least one MCG DRB, an MCG part of at least one MCG split DRB, or an MCG part of at least one SCG split DRB.

17. The terminal according to claim 15, wherein transmission of the SRB comprises: at least one of at least one MCG signaling radio bearer 1, at least one MCG signaling radio bearer 2, an MCG part of at least one MCG split signaling radio bearer 1, or an MCG part of at least one MCG split signaling radio bearer 2.

18. The terminal according to claim 14, wherein the radio link failure information of the MCG is sent by using a preset bearer; and
the preset bearer comprises: at least one of an SCG part of an MCG split radio bearer 1 or an SCG signaling radio bearer 3.

19. A first network device, wherein the first network device comprises a secondary serving cell group SCG, and comprises: a memory, a processor, and a computer program stored in the memory and executable on the processor, wherein the computer program is executed by the processor to perform:
receiving radio link failure information of a master serving cell group MCG that is sent by a terminal;
sending the radio link failure information of the MCG to the MCG;
obtaining MCG reconfiguration information; and
sending the MCG reconfiguration information to the terminal.

20. The first network device according to claim 19, wherein the computer program is executed by the processor to perform:
receiving the MCG reconfiguration information sent by the MCG in a preset manner, wherein
the preset manner comprises: at least one of an SCG part of an MCG split signaling radio bearer 1 or an Xn interface between the MCG and the SCG.
